(19) United States
(12) Patent Application Publication
(10) Pub. No.: US 2017/0262883 A1
(43) Pub. Date: Sep. 14, 2017

(54) MULTI-FUNCTIONAL MESSAGING SYSTEM

(71) Applicant: eBay Inc., San Jose, CA (US)

(72) Inventors: Shilpa Vir, Cupertino, CA (US); Venkat Tipparam, San Jose, CA (US); Harish Kumar Krishnasamy, San Jose, CA (US); Robert Lindsay Gornall, Richmond (GB); Syed Musthafa Sikkander, San Jose, CA (US); Prathiba Vasudevan, San Jose, CA (US); Chandra Nirkhe, San Jose, CA (US); Deepti Bhosale, San Jose, CA (US)

(21) Appl. No.: 15/457,412

(22) Filed: Mar. 13, 2017

Related U.S. Application Data
(60) Provisional application No. 62/306,929, filed on Mar. 11, 2016.

(51) Int. Cl. G06Q 30/02; H04L 29/08; G06Q 50/00; H04L 12/58

(52) U.S. Cl. CPC G06Q 30/0251; H04L 51/046; H04L 51/04; H04L 67/02; G06Q 50/01

(57) ABSTRACT

In some embodiments, a multi-functional messaging system comprises a data collector to collect or receive product or temporal data over a network, associate the product or temporal data with a particular product, and store the product or temporal data and an association between the product or temporal data and the particular product in a database. The system also comprises a multi-channel messaging engine to generate a message for a targeted recipient based at least on one aspect of the product or temporal data stored in the database, and select a channel from a set of channels for transmission of the message to the targeted recipient based in part on a characteristic of the selected channel. In one example, a multi-functional messaging system also comprises a transaction controller to identify and present, based on a response to the transmitted message, a landing page to the targeted recipient, the landing page associated with the product or temporal data and including a transaction flow initiator relating to the particular product, and guide the targeted recipient through at least a portion of an initiated transaction flow.

### CLAIM OF PRIORITY

This application claims the benefit of priority of U.S. Application No. 62/306,929, filed Mar. 11, 2016, which is hereby incorporated by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2016, All Rights Reserved.

### FIELD

The present disclosure relates generally to message processing and security and, in a specific example embodiment, to a multi-functional messaging system that can prioritize messages and optimize channel selection for identified events such as transactions, notifications and targeted recipients.

### BACKGROUND

Messaging content and timing in a networked system can be important aspects for users. In some aspects, appropriate channel selection for delivery of a notification message can be important. Conventional messaging systems typically do not have multi-functional capability. The present inventors seek to address these technical challenges.

### SUMMARY

Viewed broadly, the inventors have recognized that one solution to these problems can include a “smart” multi-functional messaging system that can format notification content and select or optimize a channel for communication based on communication importance and temporal data. Multi-functional capabilities, as described further below, are provided.

### BRIEF DESCRIPTION OF THE DRAWINGS

Some embodiments are illustrated by way of example and not limitation in the figures of the accompanying drawings in which:

FIG. 1 is a block diagram illustrating a network environment within which a multi-functional messaging system (MFMS) may be implemented in accordance with one example embodiment;

FIG. 2 is a block diagram illustrating a multi-functional messaging system (MFMS) in accordance with one example embodiment;

FIG. 3 shows examples of temporal data relating to a particular product in an example multi-functional messaging system (MFMS);

FIGS. 4-6 show example flows and related aspects, according to various embodiments;

FIGS. 7, and 12-15 show example landing pages, according to various embodiments;

FIGS. 8-11 shows aspects of notification messages in a multi-functional messaging system (MFMS), in accordance with example embodiments;

FIGS. 16-24 show aspects of interactive graphical user interfaces, according to various embodiments;

FIGS. 25-28 show further flows and notifications, according to various embodiments;

FIGS. 29-32 show example sequence diagrams of actions that take place during authentication and bid flows, according to various embodiments;

FIG. 33 is a flow chart of a computer-implemented method, by a multi-functional messaging system, according to various embodiments; and

FIG. 34 is a diagrammatic representation of a machine in the example form of a computer system, according to various embodiments.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

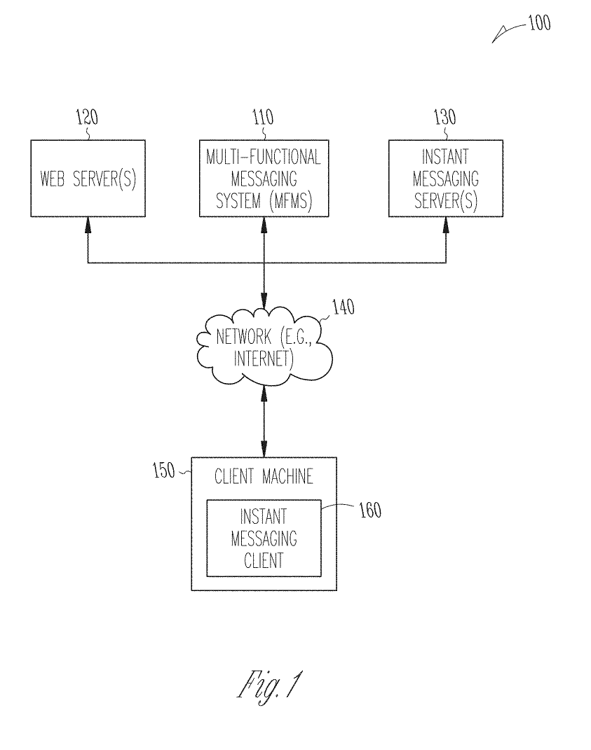

FIG. 1 is a block diagram illustrating a network environment within which a multi-functional messaging system (MFMS) may be implemented in accordance with one example embodiment. The network environment 100 may include the (MFMS) 110, one or more web servers 120, an instant messaging server 130, and one or more client machines 150 connected via a network 140 (e.g., the Internet). In one embodiment, the (MFMS) 110, the web servers 120, and the instant messaging server 130 may all be at the same location or machine. In other embodiments, however, they may all be on separate machines and connected via the network 140. The web servers 120 may host one or more websites, such as an e-commerce website, a review website that posts reviews and ratings on products, a discussion forum website, or any other website that contains product information. Web servers 120 may also host data sources such as a database containing product information.

The instant messaging server 130 may enable an instant messaging client 160 on the client machine 150 to communicate with other instant messaging clients or the (MFMS) 110. In other embodiments, however, instant messaging clients may be implemented using peer-to-peer technologies and the instant messaging server may not be needed.

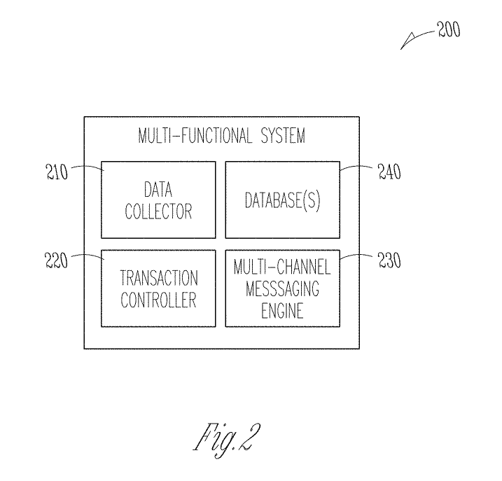

As described in greater detail below, the (MFMS) 110 is configured to collect product data from various sources and communicate with an instant messaging or email client 160 on a client machine 150. For example, the (MFMS) 110 may gather or receive product or temporal data from the one or more web servers 120 or from a separate database. The (MFMS) 110 may also engage in a dialog with a user of the instant messaging client 160 and, depending on the dialog, communicate certain information to the instant messaging client 160. The information communicated may include product information or transaction notifications, or other temporal data. Further details and components of the (MFMS) 110 will be explored below with respect to FIG. 2.

FIG. 2 is a block diagram illustrating a multi-functional messaging system (MFMS) in accordance with one example embodiment. As illustrated in FIG. 2, (MFMS) 200 may comprise a data collector 210, a transaction controller 220, a multi-channel messaging engine 230, and one or more databases 240. As described more completely below, each component may be comprised of software instructions, computer hardware components, or a combination of both. To avoid obscuring the invention in unnecessary detail, only a few of the functions are described herein.

Thus, in one example a multi-functional messaging system comprises a data collector 210 to collect or receive product or temporal data over a network, associate the product or temporal data with a particular product, and store the product or temporal data and an association between the product or temporal data and the particular product in a database.

The data collector 210 may be configured to collect various product or temporal data over a network. For example, the data collector 210 may use a web-crawling component to access various websites on the internet and extract product or temporal data associated with various products. The data collector 210 may access the website of a product manufacturer or retailer to extract product details or pricing or bidding information or may access review websites or retailer websites that contain product reviews or ratings to extract product reviews and ratings. Social networking websites where users may comment on products, share their comments about products, and discuss products with other members of their social network may also be accessed to extract product information. Other websites such as news media websites may be crawled as well in order to determine how often one or more products are mentioned. The data collector 210 may also access various databases or other information sources to extract product information or monitor communications received by the (MFMS) 200. After collecting the product data, the data collector 210 may determine that the product data is related to a particular product. In one embodiment, the data collector 210 may do this by recognizing that the product data is about the particular product. For example, when a webpage is being crawled or a database is being accessed, the data collector 210 may identify a product name, product identifier, a manufacturer name, a model number, etc. that identifies the product that the product data on that webpage is about.

All this data may be analyzed to synthesize additional product data about a product. For example, the number and nature of the product reviews, the product ratings, the date the reviews and ratings were submitted, the number of mentions in various websites over a certain period of time, or the number of instant message communications about a product received by the (MFMS) over a certain period of time may be used to generate a popularity score for a product. The data collector 210 may also store the collected and synthesized product data collected and an association between the product data and the particular product the product data is about in, for example, a database 240.

The multi-channel messaging engine 230 may be configured to generate a message for a targeted recipient based at least on one aspect of the product or temporal data stored in the database and select a channel from a set of channels for transmission of the message to the targeted recipient based in part on a characteristic of the selected channel.

The multi-channel messaging engine 230 may be configured to interact with an instant messaging client 160 of FIG. 1 either via an instant messaging server 130 or directly. The multi-channel messaging engine 230 may support one or more communication protocols including one or more instant messaging protocols. For example, the multi-channel messaging engine may determine which communication protocol a messaging client is using and configure further communications with the messaging client to conform to that communication protocol, or based on a characteristic of a selected channel. In this way, a multi-channel messaging engine 230 may send and receive communications from one instant messaging client 160 using one instant messaging protocol and send and receive communications from another instant messaging client 160 using a different instant messaging protocol.

The transaction controller 220 may be configured to identify and present, based on a response to the transmitted message, a landing page to the targeted recipient, the landing page associated with the product or temporal data and including a transaction flow initiator relating to the particular product, and guide the targeted recipient through at least a portion of an initiated transaction flow. Examples of landing pages are provided further below

The transaction controller 220 may also be configured to interpret communications from a user of an instant messaging client 160 and generate responses to the communications. In some embodiments, a natural language processor may be used to convert natural language (e.g., human language) received from the user of the instant messaging client 160 into a more formal representation that may be better understood by a machine. The natural language processor may also convert machine data, for example, information from a database, into a natural language more easily read or understood by a user.

The transaction controller 220 may engage in a conversation with a user of the instant messaging client 160, determine that a received communication is a request for product data, identify that the request corresponds with one or more products, retrieve the product data for the one or more products, and generate a response to be transmitted to the instant messaging client 160 that includes the product data.

In one example, the multi-channel messaging engine 230 may be provided in the form of an instant messaging robot to provide some of the multi-functionality of the messaging system described herein as a component thereof. For example, an instant messaging (IM) robot may be designed to interact with a user of an instant messaging client, often over a network. In some embodiments, (IM) robots are designed to simulate human interactions by using natural language processing systems to converting human language into something understandable to a machine (e.g., a computer) and converting information from a computer into natural language (e.g., human language). The (IM) robots may be configured to be compatible with one or more instant messaging protocols as well as other visually based messaging protocols such as short messaging service (SMS) protocols, multiple messaging service (MMS) protocols, or instant messaging applications embedded in web browsers.

In some embodiments the (IM) robot may include various components that gather information about a product or transaction from various sources. For example, the (IM) robot may “crawl” one or more websites and extract various product information associated with items or services. The (IM) robot may also be configured to access and examine instant message communications in order to monitor various data or search various databases or contact various servers to request product information or transaction data. A product, in this context, may be anything that may be the subject of a transaction. For example, a product may include any item or service that is able to be sold, leased, rented, etc. Products may include housing units for rent, tickets to events, menu items at restaurants, collectibles, etc. Products may also include services such as plumbing, medical or legal services, etc.

The (MFMS) may use this information to provide a user of an instant messaging client suggestions and information about one or more products. The information and suggestions may be targeted toward the particular user based on a user's interests or characteristics that are discovered through a dialog between the user and the (MFMS). For example, when a user sends, via an instant messaging protocol, a message requesting product information to the (MFMS), the (MFMS) may attempt to determine or narrow down suggestions or product information to those that match a user's interests. This may involve prompting the user for additional information or search criteria. At some point, the (MFMS) may perform a search and identify one or more products that are compatible with a user's interests. Then the (MFMS) may respond to the user with information about the product. For example, the (MFMS) may supply the user with details about the product, product ratings, comments from users or owners of the product, a popularity level of a product, and a link to more information about the product, a link to purchase the product, etc. In this way, certain embodiments of the (MFMS) may provide a benefit to the user by providing suggestions or product information targeted to the particular user. Certain embodiments of the (MFMS) may also provide a benefit to one or more websites by directing users interested in a particular product to the product site where the users may make a purchase.

In some embodiments where a user makes a purchase on a website associated with the (MFMS), the (MFMS) may send a notification messages to the user via the user's instant messaging client. For example, the (MFMS) may send a notification message to the user to inform them that the user's payment has posted or that the item has shipped. In one embodiment, a user may request the status of one or more transactions from the (MFMS) and the (MFMS) may retrieve the statuses of the one or more transactions and communicate them to the user via the instant messaging protocol. In this way, the user may receive notifications and status updates without having to check their email account or login to the website.

Features of an (MFMS) for delivering notifications in an example auction environment are now described. For example, the last few minutes, especially fifteen minutes, of an auction are important sessions for bid activity. Notification content, accuracy, and appropriate channel selection for such notifications are important factors for a successful outcome for a bidder. It will be appreciated that other use cases for smart messaging are possible.

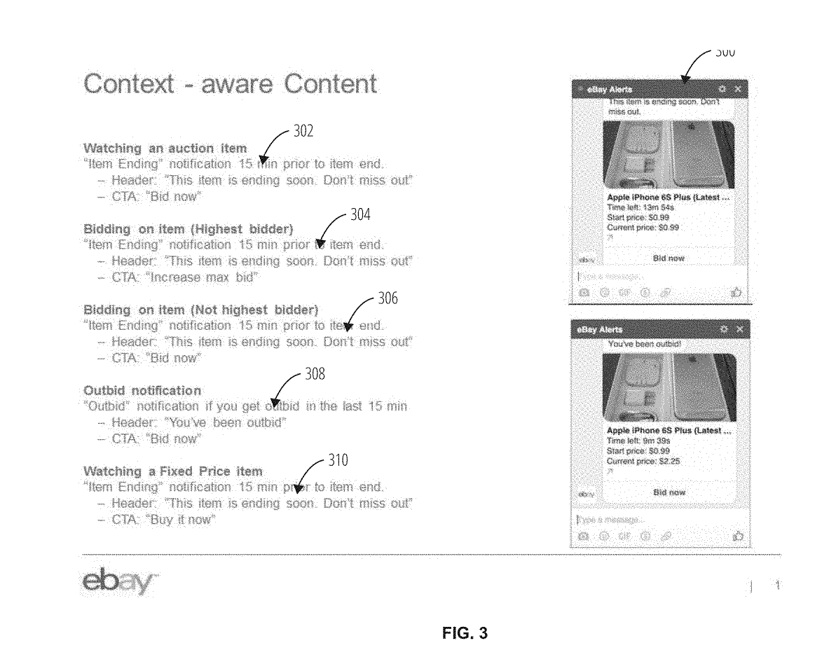

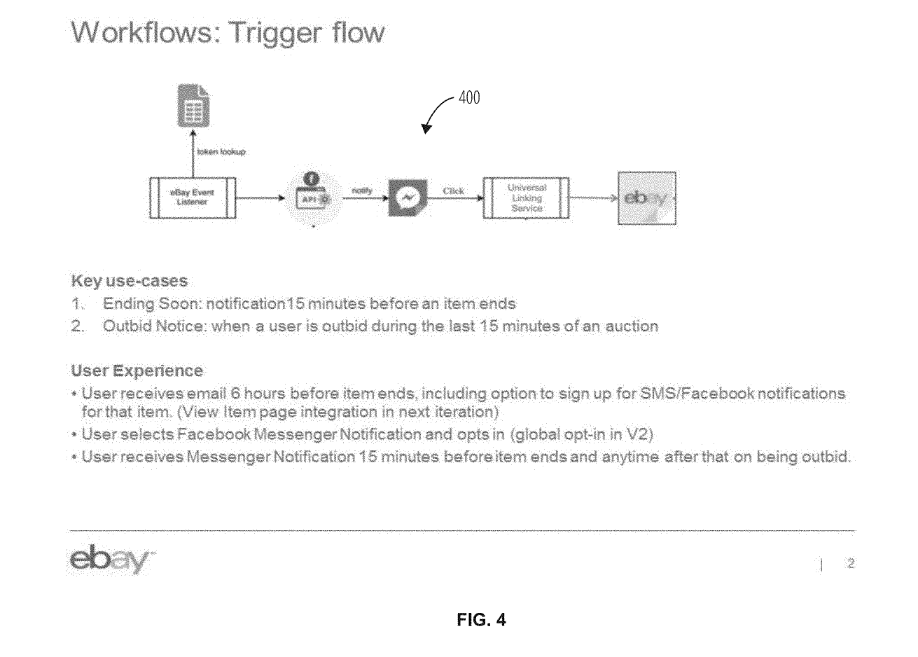

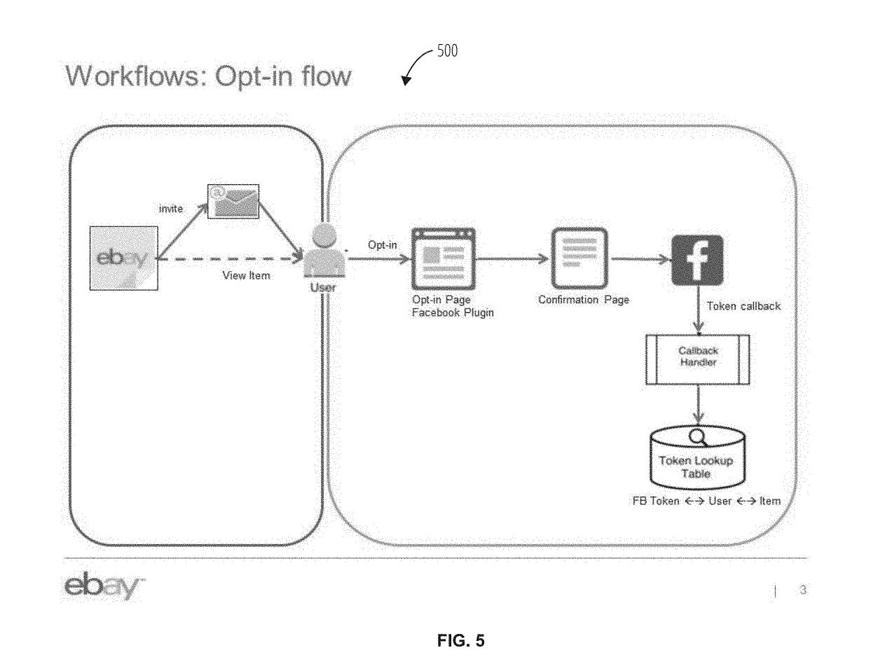

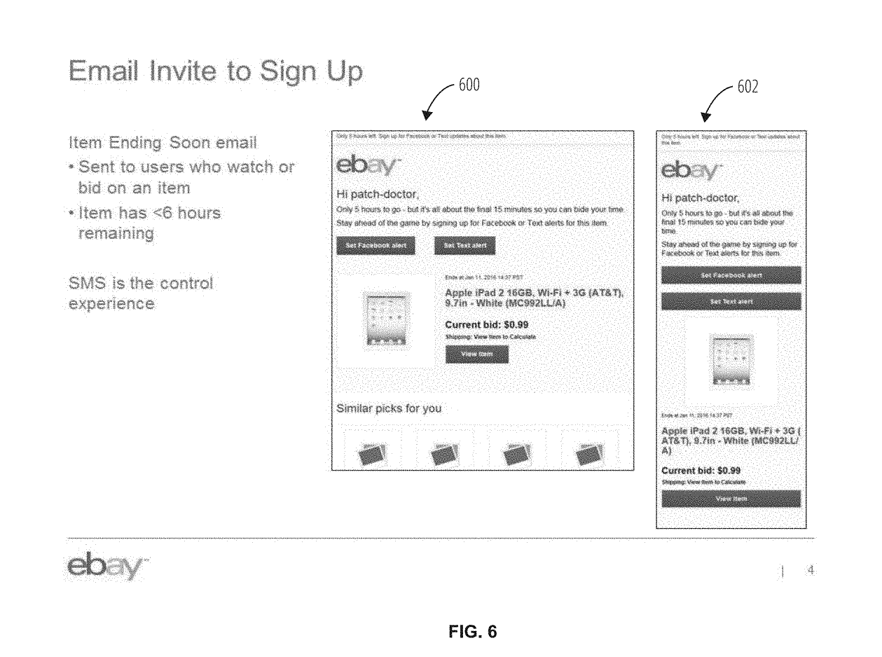

FIG. 3 provides examples at 302-310 of temporal data relating to a particular product 300 in an example (MFMS). The illustrated temporal data relates to watching or bidding on an item in an auction. The particular product in this example is an iPhone 6S. FIG. 4 shows an example workflow 400 for a notification (or message) trigger. FIG. 5 shows an example opt-in flow 500 for a targeted recipient to receive messages from an example (MFMS). FIG. 6 shows at 600 and 602 examples of email invitation in this regard.

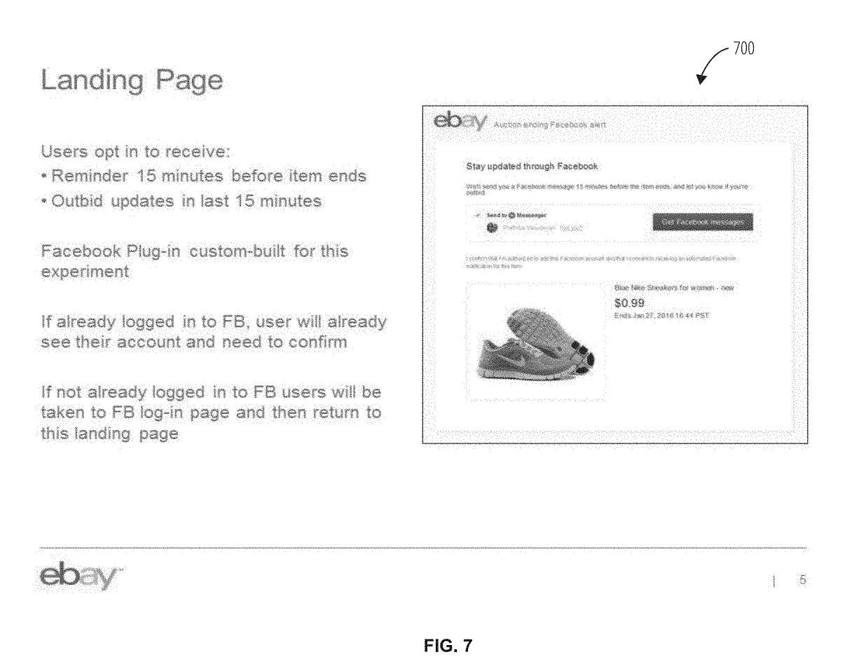

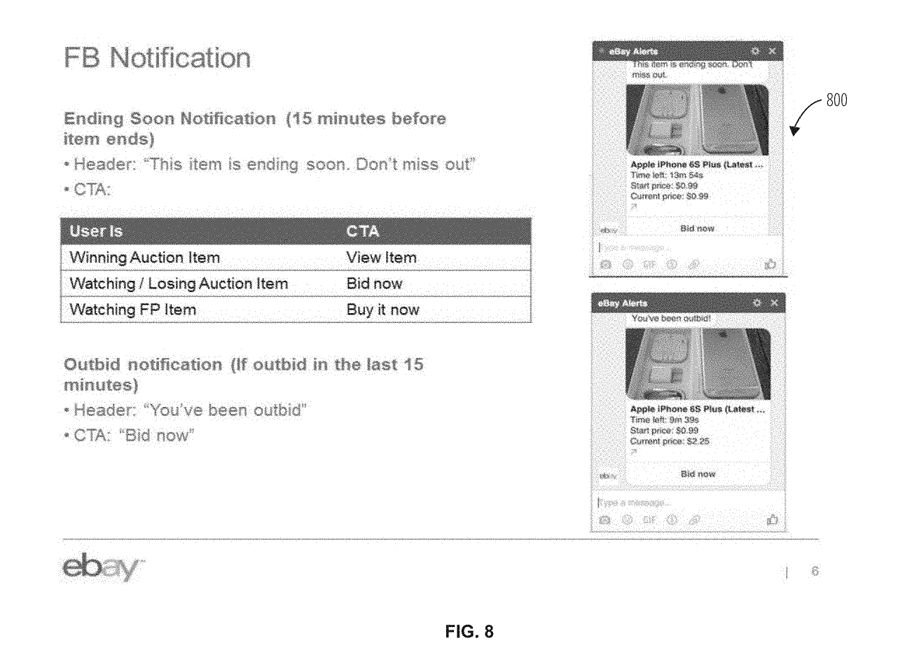

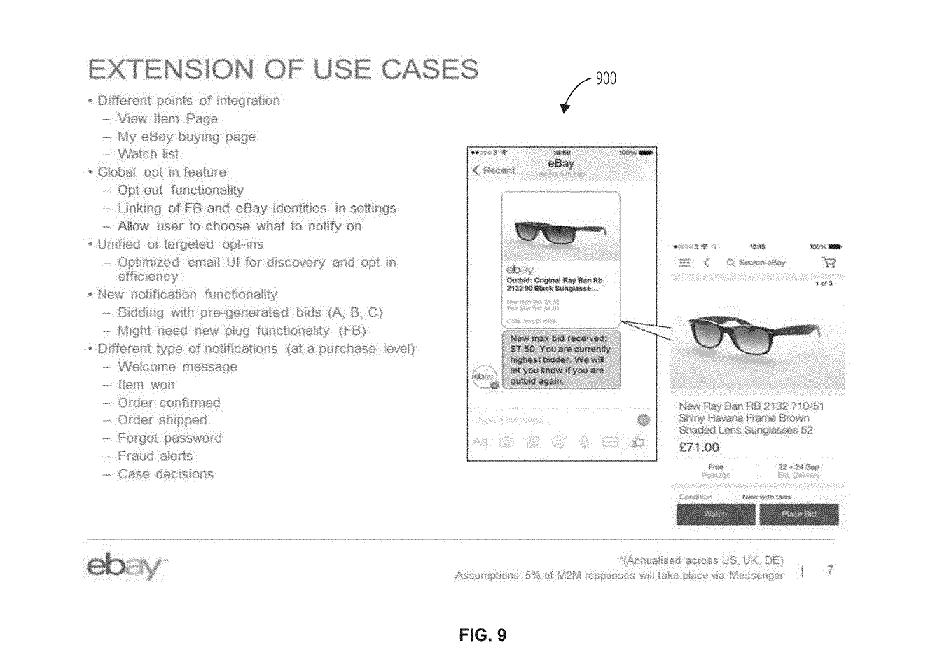

Other avenues to expose users to this feature can include an “outbid email”, as well as integration of an automatic messaging function into a messaging or web-based platform. An “outbid email” or similar message can include item details or a link to a page listing same, a “my eBay” link, and user preferences, for example. FIG. 7 shows an example landing page in this regard, which includes such notification messages. The optimum timing and content for such notifications, as well as the right content and logic, can be tailored as appropriate. An example of a Facebook notification in this regard is shown at 800 in FIG. 8. Other examples of particular products, product and temporal data are shown more generally at 900 in FIG. 9.

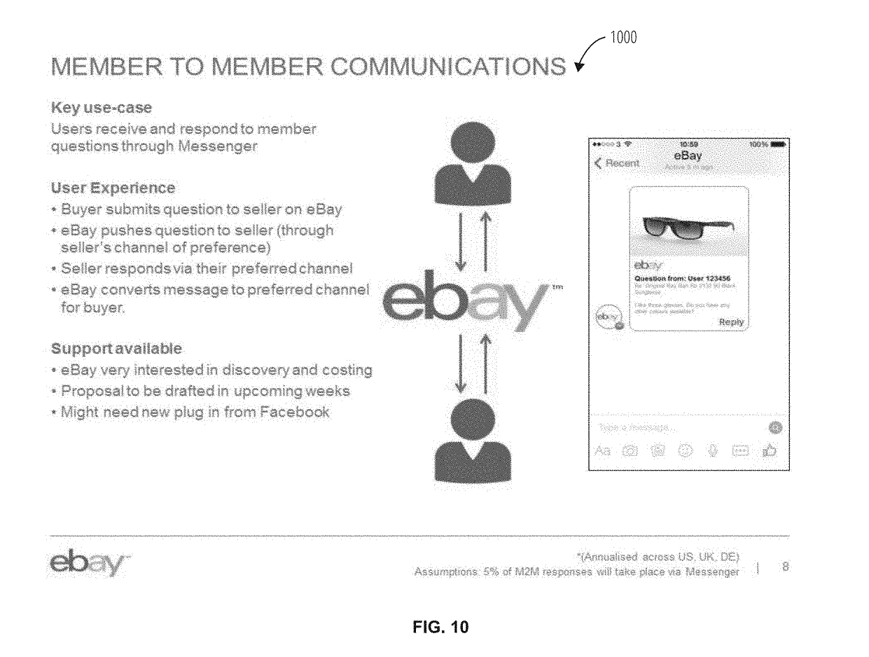

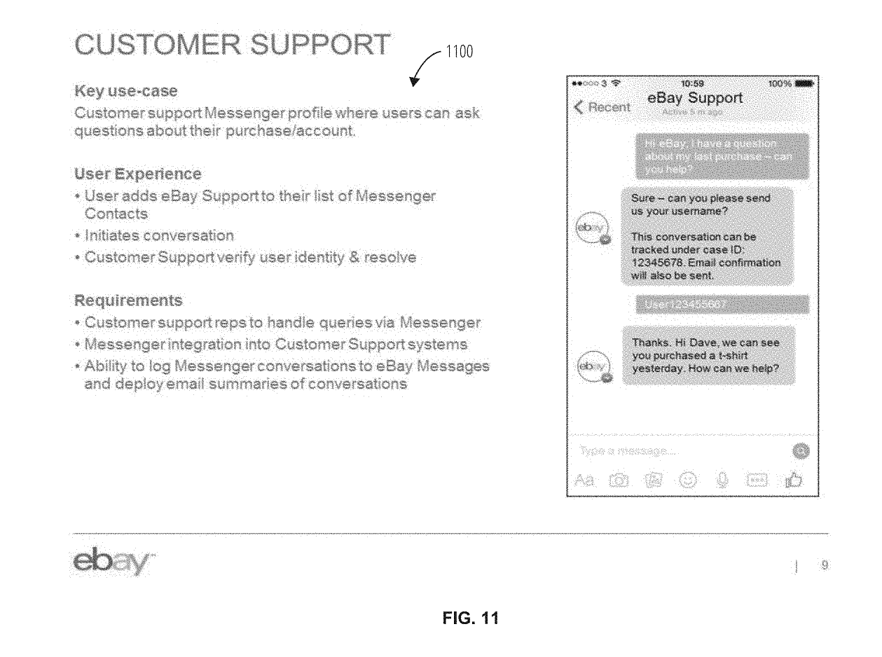

Member to member communications in a multi-functional messaging system (MFMS) are also possible, for example as shown in FIG. 10. By intervening at 1100 as a participant in a messaging service, the multi-channel messaging engine 230 can enhance customer support, for example as shown in FIG. 11.

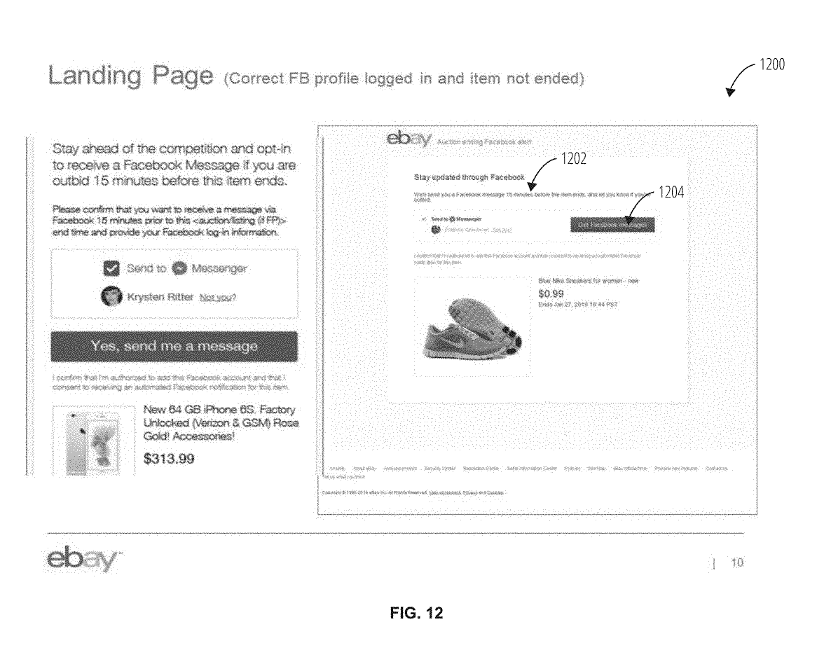

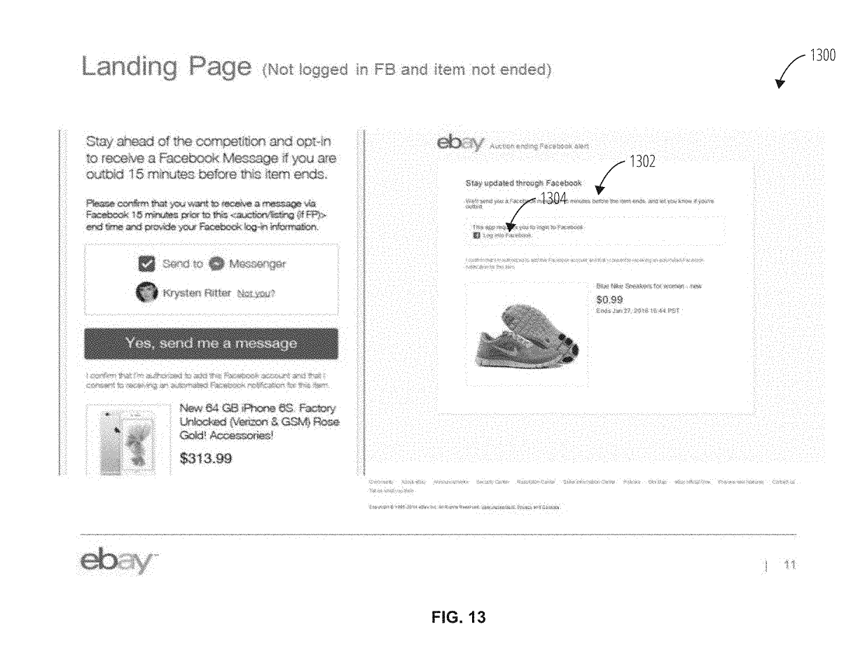

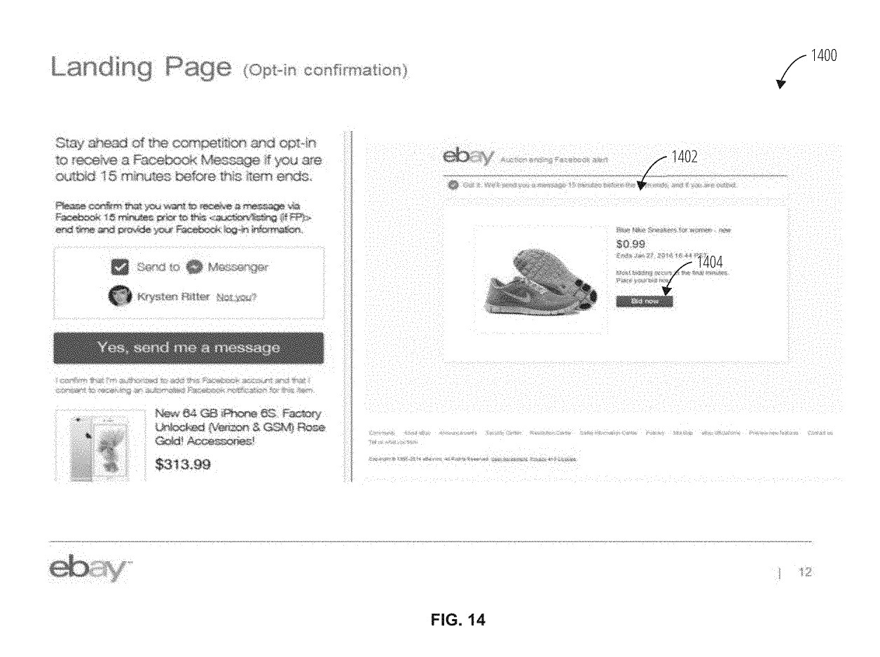

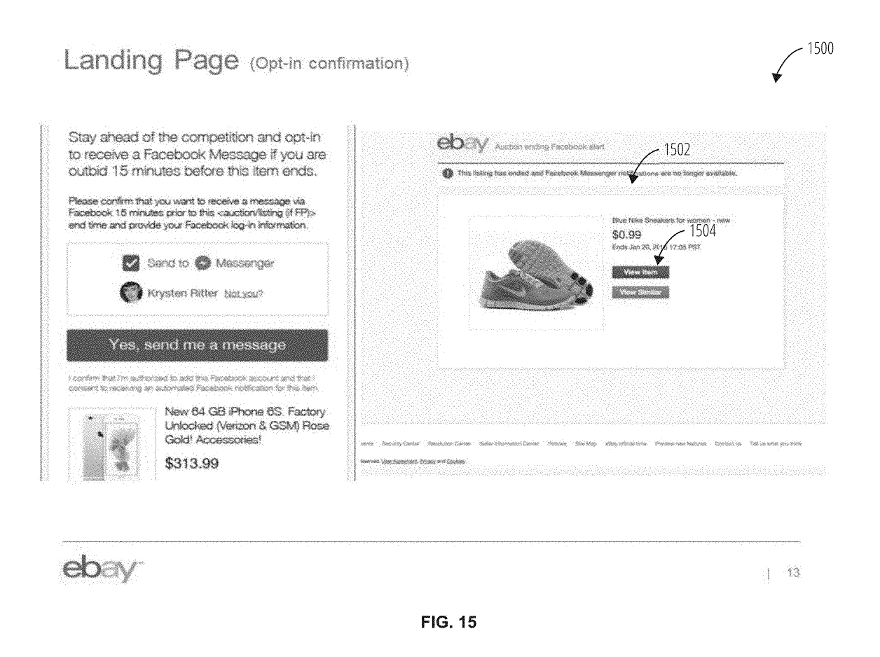

Other aspects of a multifunctional messaging system, including landing pages used by the transaction controller 220 in FIG. 2, can include examples 1200, 1300, 1400, and 1500 shown in FIGS. 12-15. Each landing page has example information elements 1202 and action elements 1204 in example transaction flows as variously shown in the views (and numbered respectively).

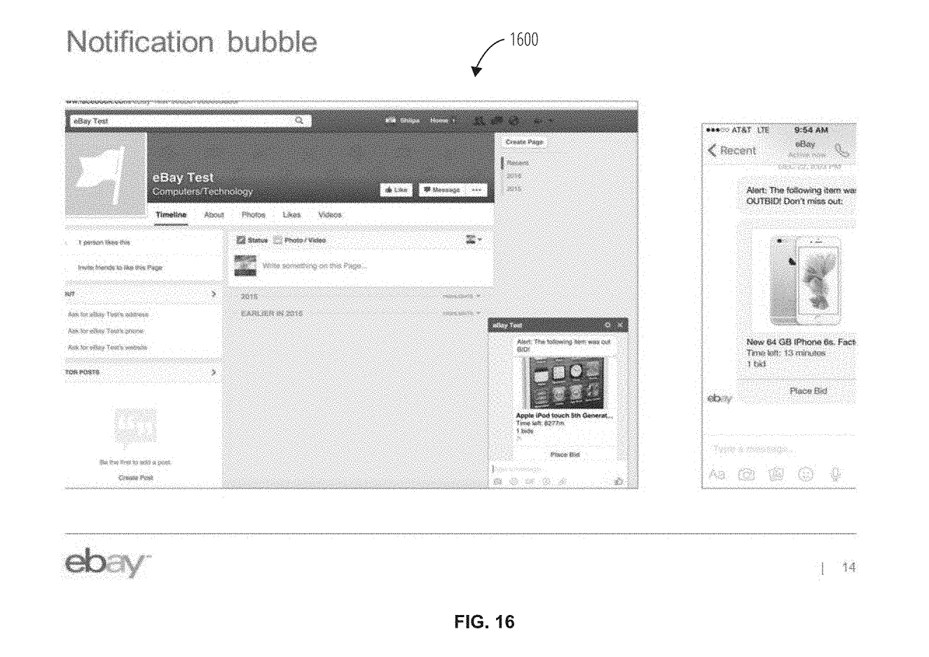

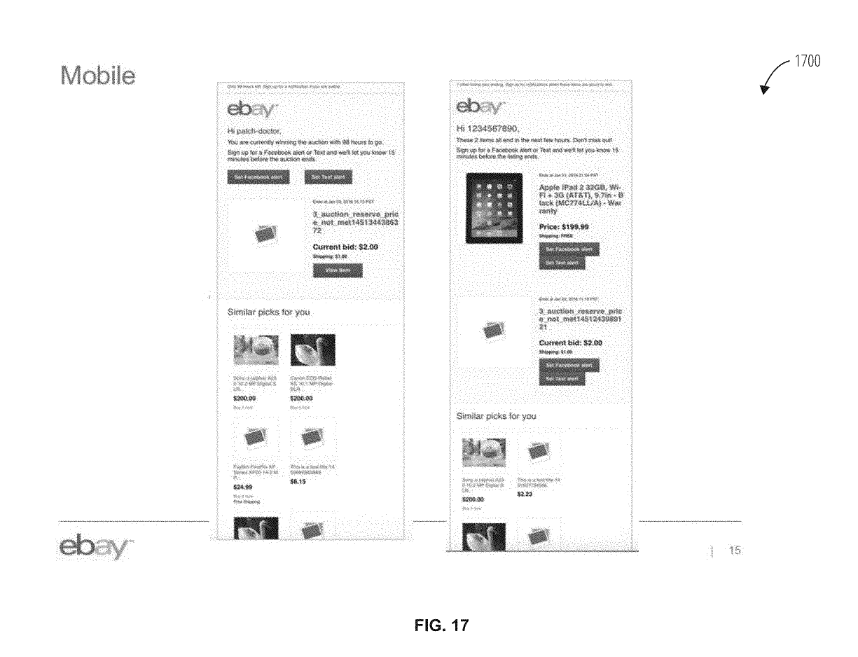

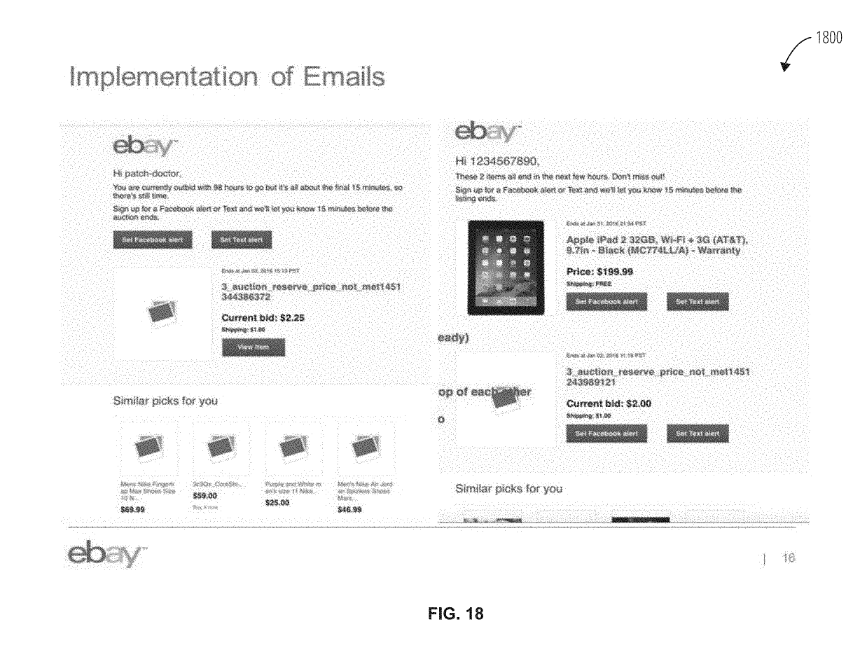

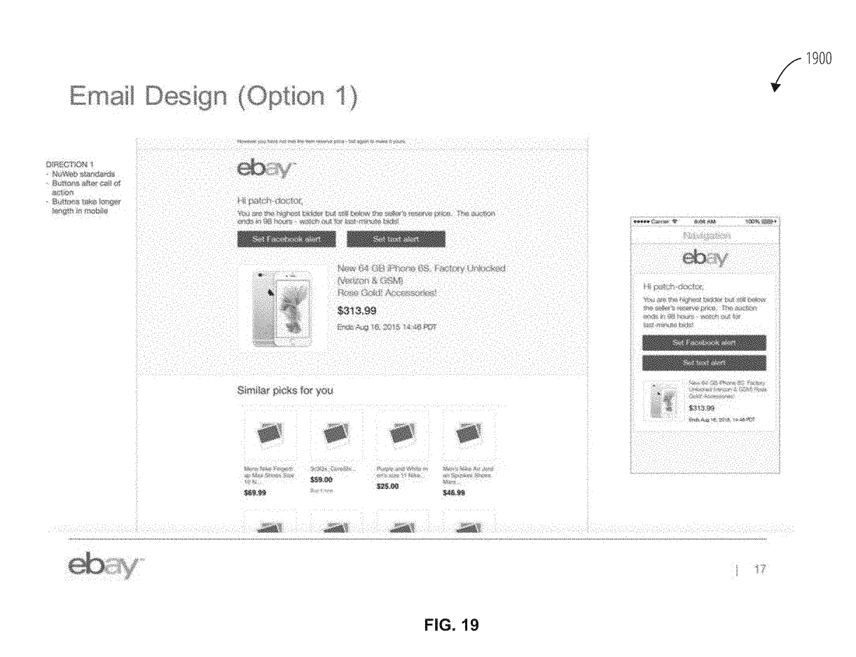

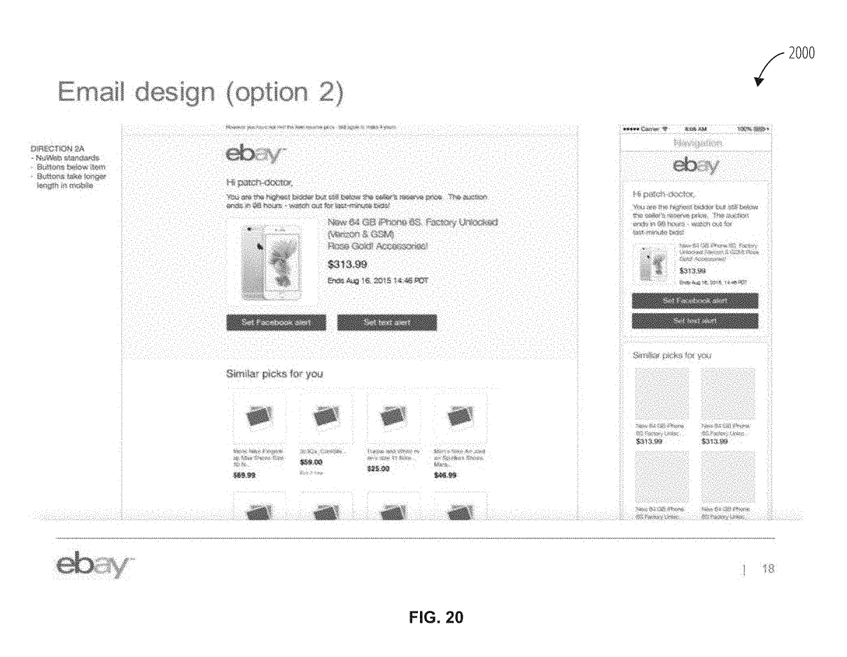

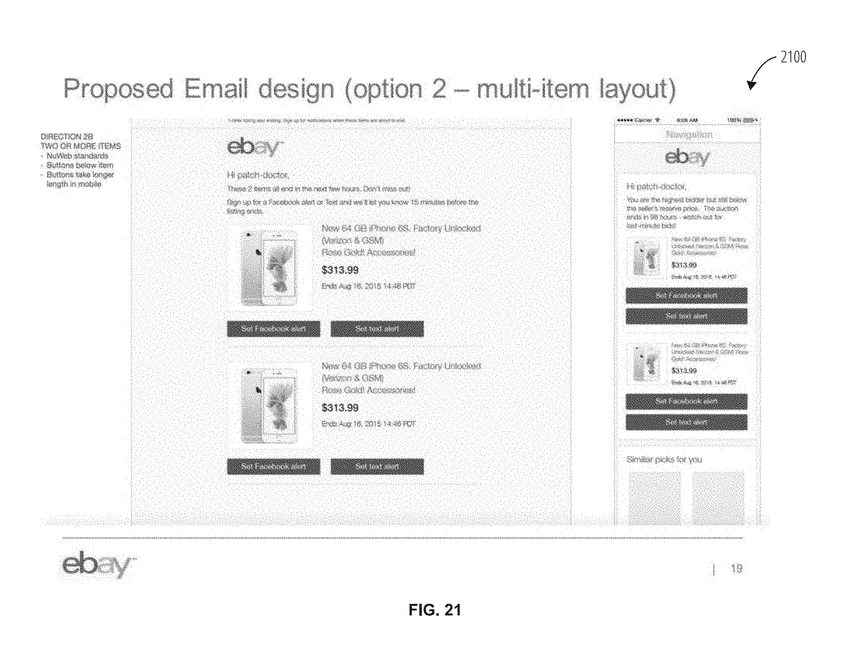

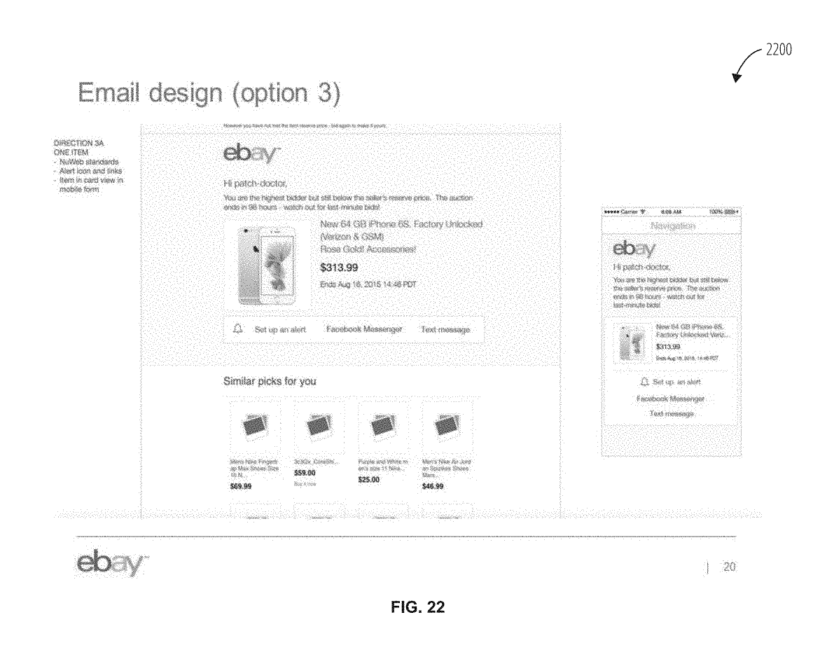

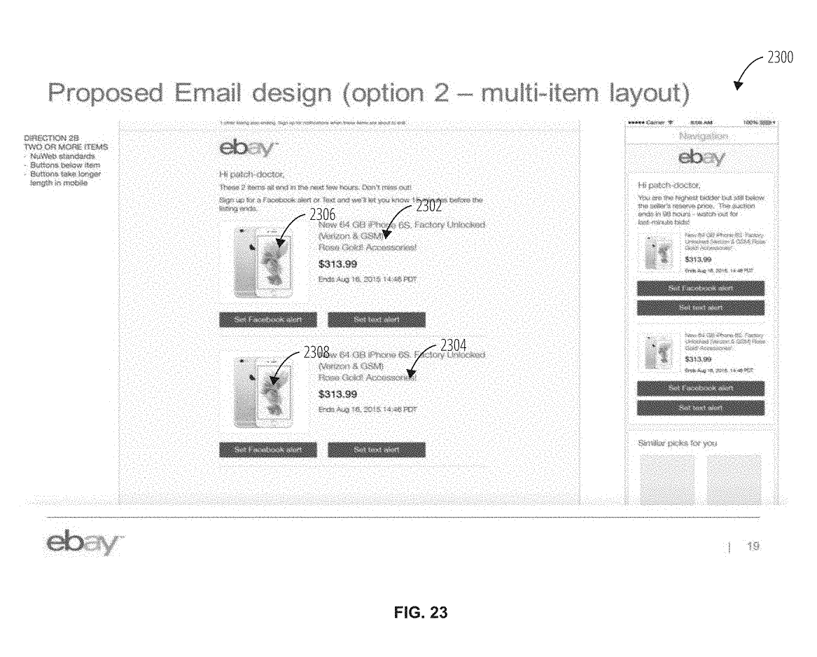

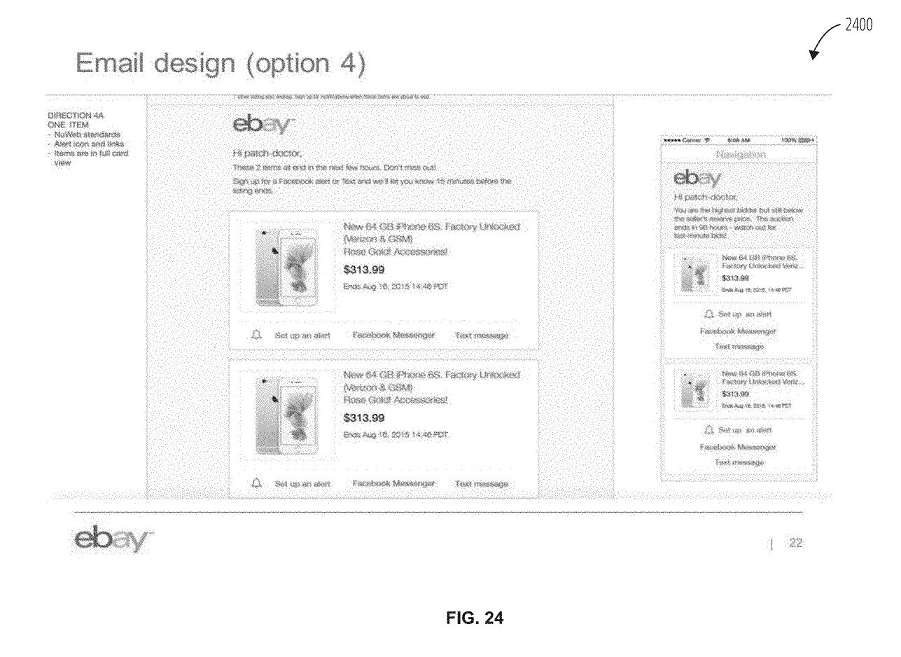

Interactive graphical user interface elements for a multi-functional messaging system can include the elements and landing pages shown in FIGS. 16-24. Web-based, email and mobile implementations are possible, as shown. Thus, in some examples, selecting a channel for transmission of a notification message includes selecting an instant messaging (IM) or email channel. A channel type of the channel selected for transmission of the message may be different to a channel type of a channel by which a response to the transmitted message may be received. With particular reference to the multi-item views in FIGS. 21-23, a selected landing page includes or defines a transaction hub presenting a plurality of transaction flow initiators e.g. 2302 and 2304 relating to a plurality of respective particular products e.g. iPhones 2306 and 2308. As shown, in some instances, collecting the product or temporal data over the network comprises accessing a website containing the product or temporal data, and monitoring instant message communications.

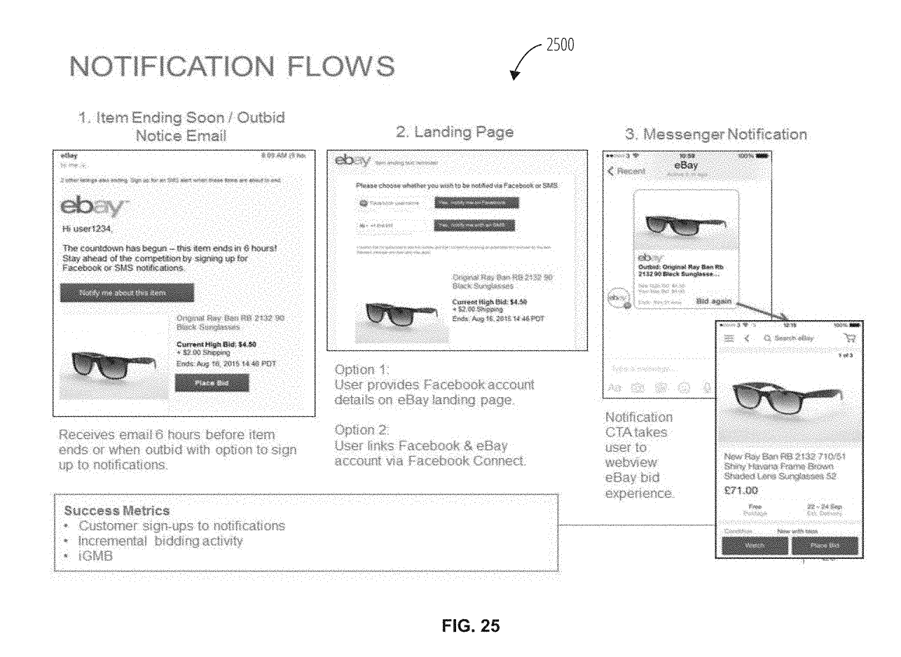

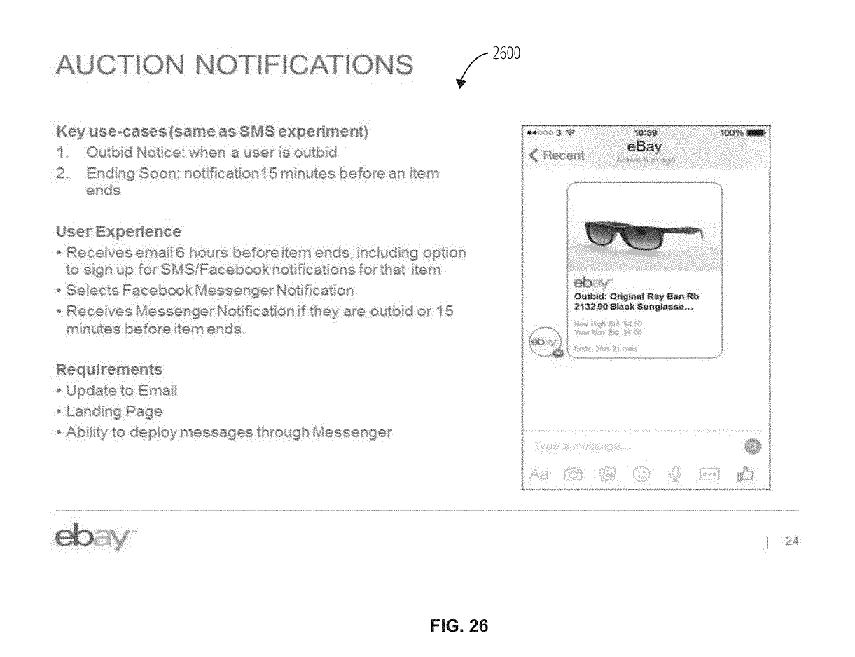

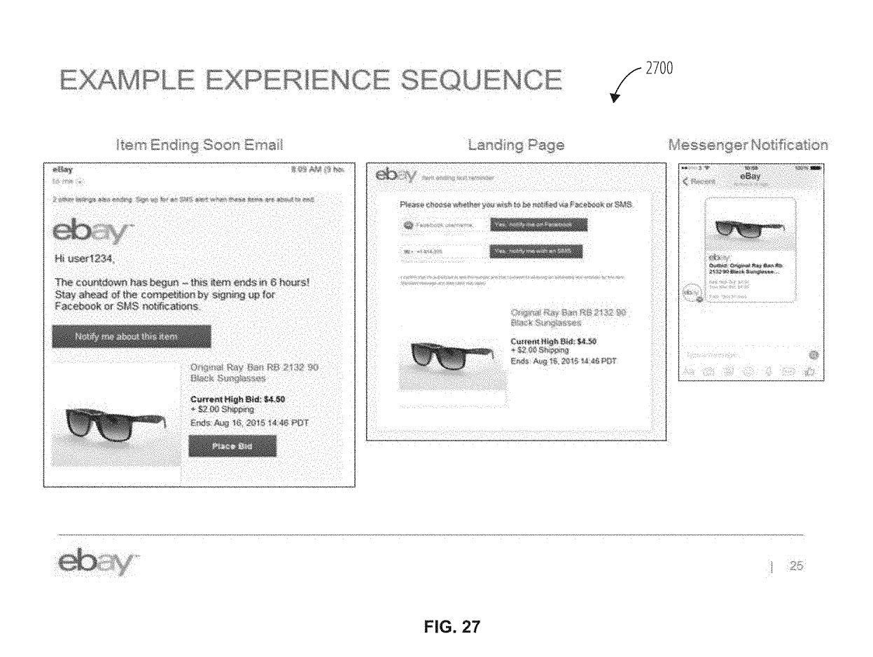

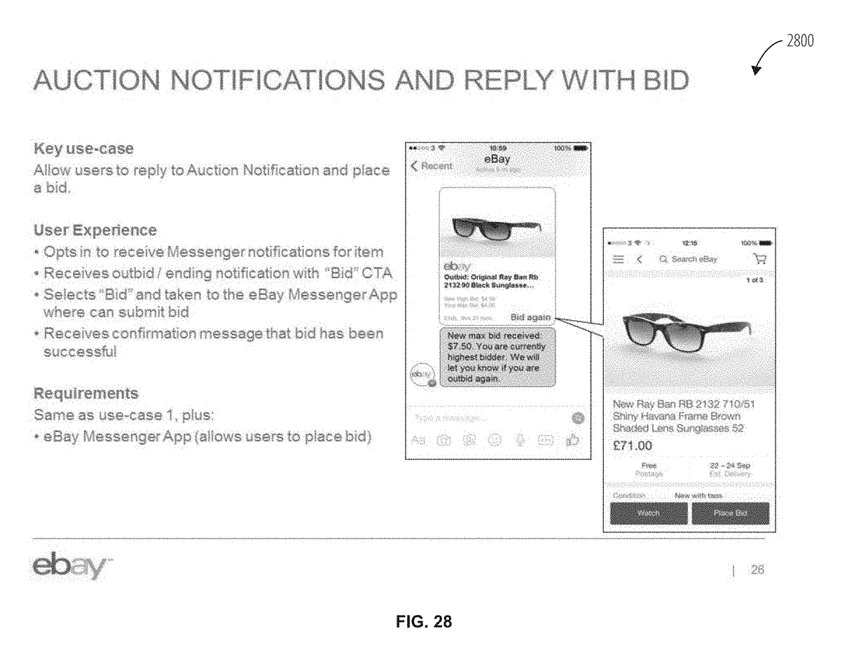

Example notification flows in a multi-functional messaging system can include the flow 2500 illustrated in FIG. 25. Example auction notifications are shown at 2600 in FIG. 26. An example user experience for a (MFMS) of the present disclosure is shown at 2700 in FIG. 27. An example auction notification and reply with bid is shown at 2800 in FIG. 28. This is another example of a transaction hub.

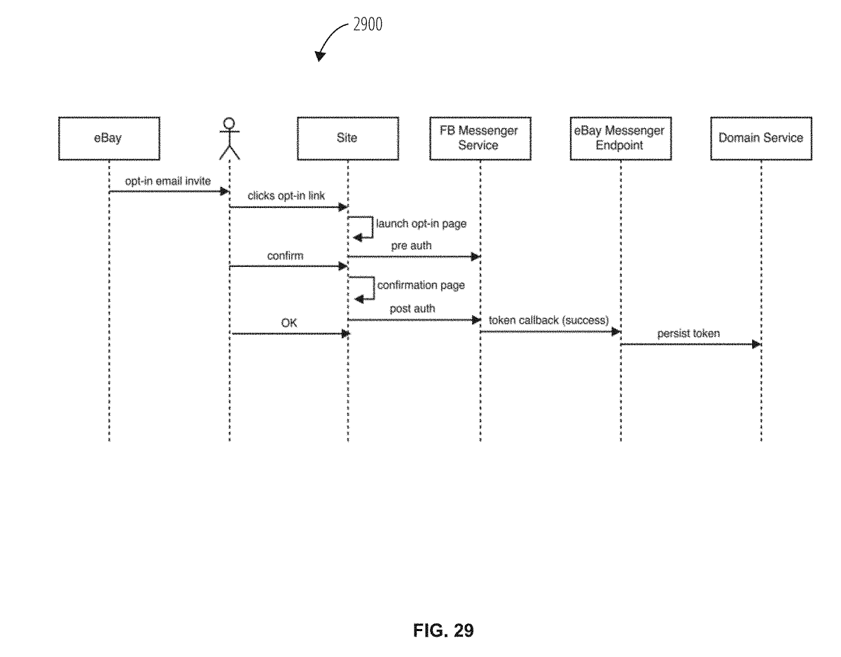

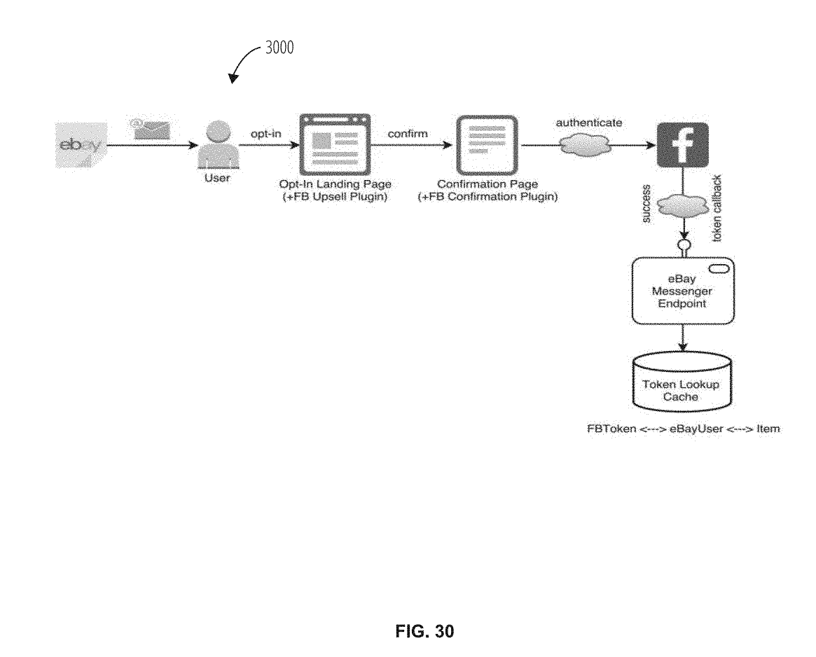

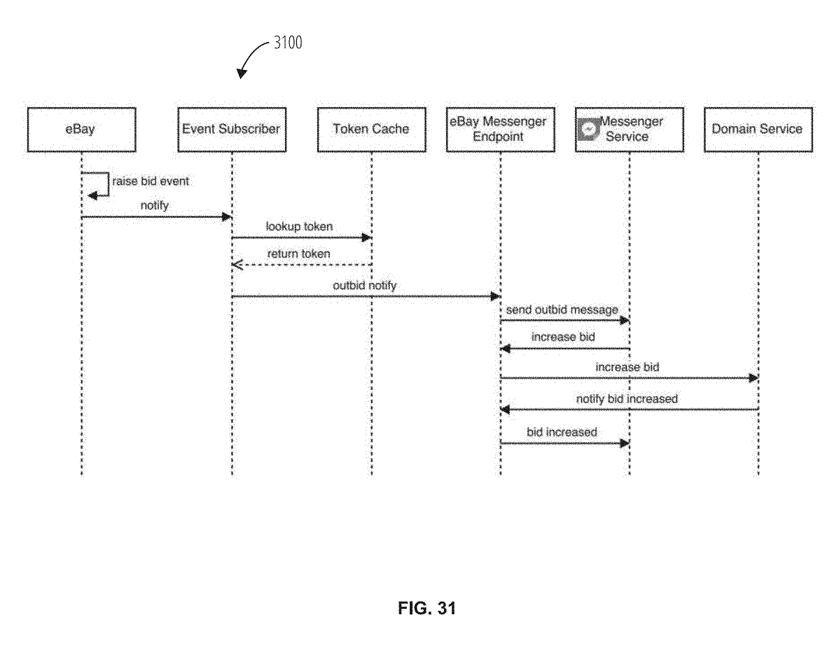

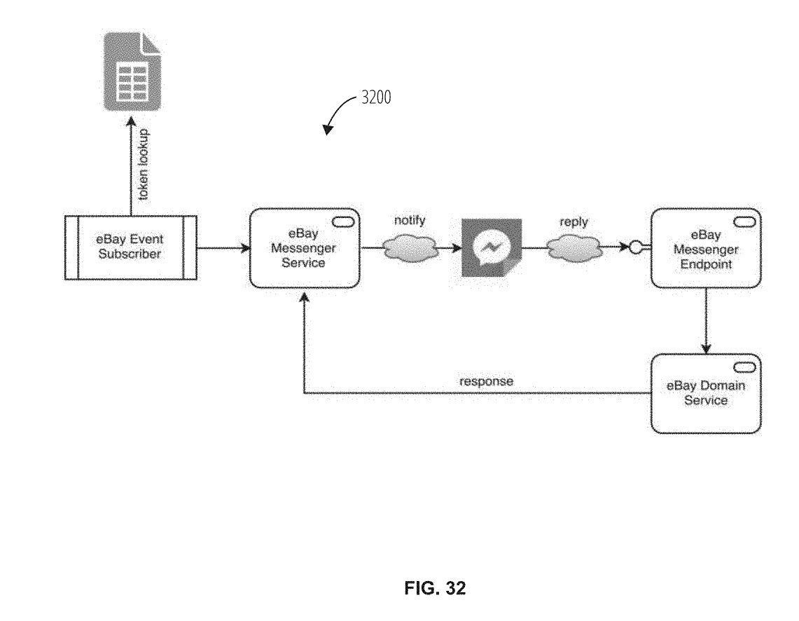

Example sequence diagrams of actions that take place during authentication and bid flows are provided in FIGS. 29-32. An example authentication flow sequence diagram is shown at 2900 in FIG. 29. An example authentication flow diagram is shown at 3000 in FIG. 30. An example bid flow sequence diagram is shown at 3100 in FIG. 31. An example bid flow diagram is shown at 3200 in FIG. 32.

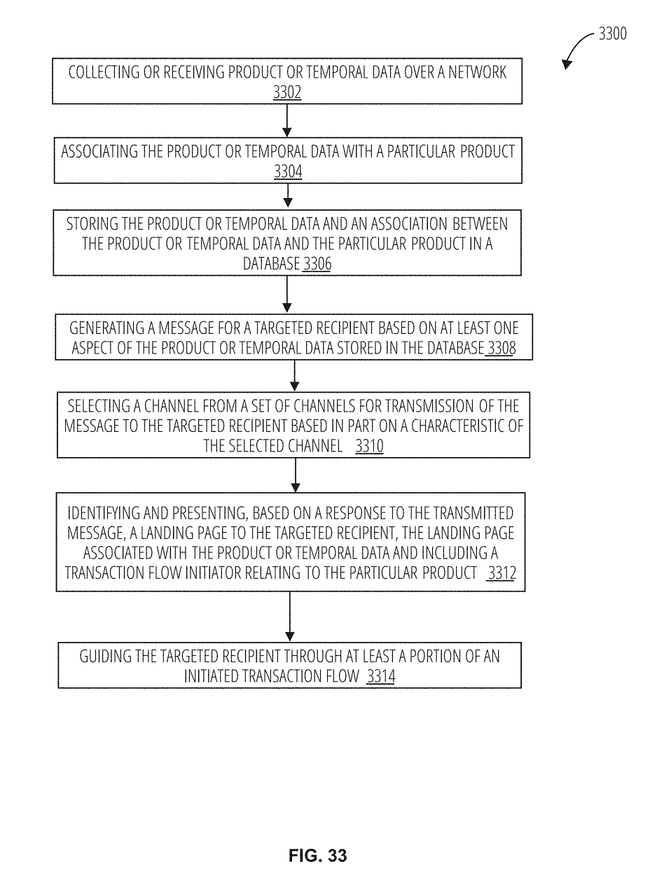

Some of the embodiments of the present disclosure also include method embodiments. With reference to FIG. 33, a computer-implemented method 3300, by a multi-functional messaging system, comprises at 3302, collecting or receiving product or temporal data over a network; at 3304, associating the product or temporal data with a particular product; at 3306, storing the product or temporal data and an association between the product or temporal data and the particular product in a database; at 3308, generating a message for a targeted recipient based at least on one aspect of the product or temporal data stored in the database; at 3310, selecting a channel from a set of channels for transmission of the message to the targeted recipient based in part on a characteristic of the selected channel; at 3312, identifying and presenting, based on a response to the transmitted message, a landing page to the targeted recipient, the landing page associated with the product or temporal data and including a transaction flow initiator relating to the particular product; and, at 3314, guiding the targeted recipient through at least a portion of an initiated transaction flow.

In some embodiments, selecting a channel for transmission of the message may include selecting an instant messaging (IM) or email channel. A channel type of the channel selected for transmission of the message may be different to a channel type of a channel by which the response to the transmitted message is received. The selected landing page may include or define a transaction hub presenting a plurality of transaction flow initiators relating to a plurality of respective particular products. Collecting the product or temporal data over the network may comprise accessing a website containing the product or temporal data, and monitoring instant message communications.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

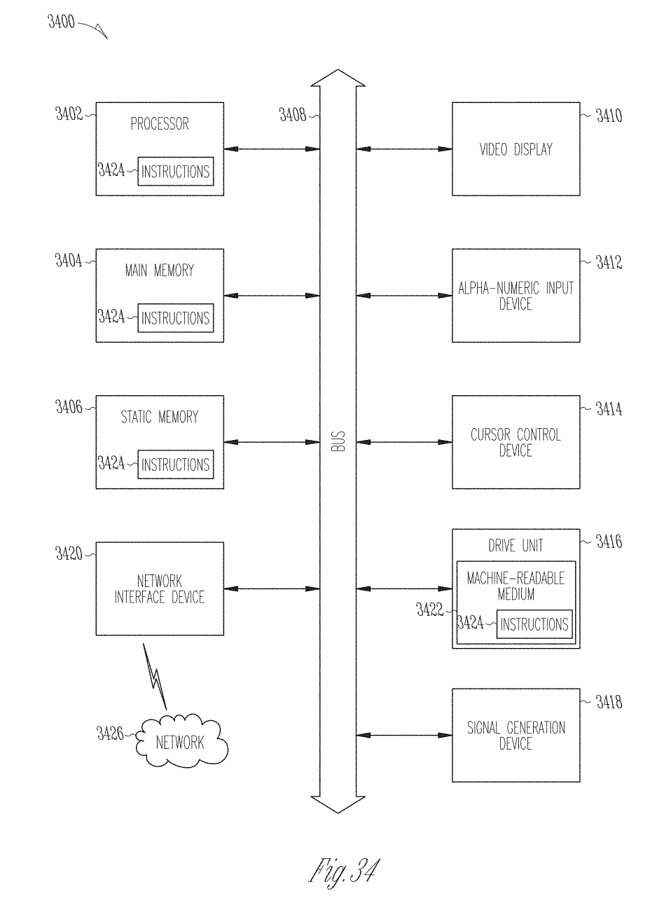

FIG. 34 shows a block diagram of machine in the example form of a computer system 3400 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 3400 includes a processor 3402 (e.g., a central processing unit (CPU), a graphics processing unit (GPU) or both), a main memory 3404 and a static memory 3406, which communicate with each other via a bus 3408. The computer system 3400 may further include a video display unit 3410 (e.g., a liquid crystal display (LCD) or a cathode ray tube (CRT)). The computer system 3400 also includes an alphanumeric input device 3412 (e.g., a keyboard), a user interface (UI) navigation device 3414 (e.g., a mouse), a disk drive unit 3416, a signal generation device 3418 (e.g., a speaker) and a network interface device 3420.

The disk drive unit 3416 includes a machine-readable medium 3422 on which is stored one or more sets of instructions and data structures (e.g., software) 3424 embodying or utilized by any one or more of the methodologies or functions described herein. The instructions 3424 may also reside, completely or at least partially, within the main memory 3404 and/or within the processor 3402 during execution thereof by the computer system 3400, the main memory 3404 and the processor 3402 also constituting machine-readable media.

While the machine-readable medium 3422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 3424 may further be transmitted or received over a communications network 3426 using a transmission medium. The instructions 3424 may be transmitted using the network interface device 3420 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A multi-functional messaging system comprising:
a data collector to:
collect or receive product or temporal data over a network,
associate the product or temporal data with a particular product, and
store the product or temporal data and an association between the product or temporal data and the particular product in a database;
a multi-channel messaging engine to:
generate a message for a targeted recipient based at least on one aspect of the product or temporal data stored in the database; and
select a channel from a set of channels for transmission of the message to the targeted recipient based in part on a characteristic of the selected channel; and
a transaction controller to:
identify and present, based on a response to the transmitted message, a landing page to the targeted recipient, the landing page associated with the product or temporal data and including a transaction flow initiator relating to the particular product, and
guide the targeted recipient through at least a portion of an initiated transaction flow.

2. The multi-functional messaging system of claim 1, wherein the selected channel for transmission of the message is an instant messaging (IM) or email channel.

3. The multi-functional messaging system of claim 1, wherein a channel type of the channel selected for transmission of the message is different to a channel type of a channel by which the response to the transmitted message is received.

4. The multi-functional messaging system of claim 1, wherein the selected landing page includes or defines a transaction hub presenting a plurality of transaction flow initiators relating to a plurality of respective particular products.

5. The multi-functional messaging system of claim 1, wherein collecting the product or temporal data over the network comprises accessing a website containing the product or temporal data, and monitoring instant message communications.

6. A computer-implemented method, by a multi-functional messaging system, comprising:
collecting or receiving product or temporal data over a network;
associating the product or temporal data with a particular product;
storing the product or temporal data and an association between the product or temporal data and the particular product in a database;
generating a message for a targeted recipient based at least on one aspect of the product or temporal data stored in the database;
selecting a channel from a set of channels for transmission of the message to the targeted recipient based in part on a characteristic of the selected channel;
identifying and presenting, based on a response to the transmitted message, a landing page to the targeted recipient, the landing page associated with the product or temporal data and including a transaction flow initiator relating to the particular product; and
guiding the targeted recipient through at least a portion of an initiated transaction flow.

7. The method of claim 6, wherein selecting a channel for transmission of the message includes selecting an instant messaging (IM) or email channel.

8. The method of claim 6, wherein a channel type of the channel selected for transmission of the message is different to a channel type of a channel by which the response to the transmitted message is received.

9. The method of claim 6, wherein the selected landing page includes or defines a transaction hub presenting a plurality of transaction flow initiators relating to a plurality of respective particular products.

10. The method of claim 6, wherein collecting the product or temporal data over the network comprises accessing a website containing the product or temporal data, and monitoring instant message communications.

11. A machine-readable medium comprising instructions which, when read by a machine, cause the machine to perform operations comprising, at least:
collecting or receiving product or temporal data over a network;
associating the product or temporal data with a particular product;
storing the product or temporal data and an association between the product or temporal data and the particular product in a database;
generating a message for a targeted recipient based at least on one aspect of the product or temporal data stored in the database;
selecting a channel from a set of channels for transmission of the message to the targeted recipient based in part on a characteristic of the selected channel;
identifying and presenting, based on a response to the transmitted message, a landing page to the targeted recipient, the landing page associated with the product or temporal data and including a transaction flow initiator relating to the particular product, and
guiding the targeted recipient through at least a portion of an initiated transaction flow.

12. The medium of claim 11, wherein selecting a channel for transmission of the message includes selecting an instant messaging (IM) or email channel.

13. The medium of claim 11, wherein a channel type of the channel selected for transmission of the message is different to a channel type of a channel by which the response to the transmitted message is received.

14. The medium of claim 11, wherein the selected landing page includes or defines a transaction hub presenting a plurality of transaction flow initiators relating to a plurality of respective particular products.

15. The medium of claim 6, wherein collecting the product or temporal data over the network comprises accessing a website containing the product or temporal data, and monitoring instant message communications.
